(19) United States
(12) Patent Application Publication
(10) Pub. No.: US 2025/0384688 A1
(43) Pub. Date: Dec. 18, 2025

(54) CONTROL APPARATUS, IMAGE CAPTURING CONTROL METHOD, AND MEDIUM

(71) Applicant: CANON KABUSHIKI KAISHA, Tokyo (JP)

(72) Inventor: Yoshito ANDO, Tochigi (JP)

(21) Appl. No.: 19/231,632

(22) Filed: Jun. 9, 2025

(30) Foreign Application Priority Data
Jun. 12, 2024 (JP) 2024-095374

(51) Int. Cl. G06V 20/40; G06V 10/26; G06V 20/52; G06V 40/20; H04N 23/61; H04N 23/69; H04N 23/695

(52) U.S. Cl. CPC G06V 20/49; G06V 10/26; H04N 23/61; H04N 23/69; H04N 23/695; G06V 20/53; G06V 40/20

(57) ABSTRACT

A control apparatus identifies content of a video. The control apparatus determines a video cutting type indicating a relationship between videos at a time of switching video from a first video captured by a first image capturing device in accordance with a result of identifying content of the first video. The control apparatus determines whether a result of identifying content of a second video captured by a second image capturing device satisfies a condition corresponding to the video cutting type. The second image capturing device captures the second video while changing an angle of view. The control apparatus determines that the first video can be switched to the second video based on a result of the determination that the condition is satisfied.

### BACKGROUND

### Field of the Technology

The present disclosure relates to a control apparatus, an image capturing control method, and a medium, in particular, a method for controlling an image capturing device in a system for capturing video using a plurality of image capturing devices.

### Description of the Related Art

In recent years, there has been an increasing demand for live distribution and video production. For example, video may be captured for entertainment such as a music event, a play, or a sporting spectacle. It is possible to perform such image capturing from multiple viewpoints using a plurality of image capturing devices at the same time. In such cases, video to be distributed can be selected from the plurality of videos captured from multiple viewpoints. In such cases, a control device called a switcher is used.

Techniques for automatically controlling the angle of view of at least one camera when capturing images using a plurality of cameras are also known. For example, Japanese Patent Laid-Open No. 2019-186635 discloses a technique of controlling a second image capturing device so as to, when the user designates an arbitrary region in an image captured by a first image capturing device, capture a region overlapping with the designated region.

### SUMMARY

According to an embodiment of the present disclosure, it is possible to, in a technique for switching videos from a plurality of image capturing devices, make less unnatural video switching easier.

According to an embodiment, a control apparatus identifies content of a video. The control apparatus determines a video cutting type indicating a relationship between videos at a time of switching video from a first video captured by a first image capturing device in accordance with a result of identifying content of the first video. The control apparatus determines whether a result of identifying content of a second video captured by a second image capturing device satisfies a condition corresponding to the video cutting type. The second image capturing device captures the second video while changing an angle of view. The control apparatus determines that the first video can be switched to the second video based on a result of the determination that the condition is satisfied.

According to another embodiment, an image capturing control method comprises: identifying content of a video; determining a video cutting type indicating a relationship between videos at a time of switching video from a first video captured by a first image capturing device in accordance with a result of identifying content of the first video; determining whether a result of identifying content of a second video captured by a second camera device satisfies a condition corresponding to the video cutting type, wherein the second camera device captures the second video while changing an angle of view; and determining that the first video can be switched to the second video based on a result of the determination that the condition is satisfied.

According to still another embodiment, a non-transitory computer-readable medium stores a program executable by a computer to perform a method. The method comprises: identifying content of a video; determining a video cutting type indicating a relationship between videos at a time of switching video from a first video captured by a first image capturing device in accordance with a result of identifying content of the first video; determining whether a result of identifying content of a second video captured by a second camera device satisfies a condition corresponding to the video cutting type, wherein the second camera device captures the second video while changing an angle of view; and determining that the first video can be switched to the second video based on a result of the determination that the condition is satisfied.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating an exemplary configuration of an image capturing system according to an embodiment.

FIG. 2 is a view illustrating an example of a hardware configuration of the image capturing system according to an embodiment.

FIG. 3 is a view illustrating an example of a functional configuration of the image capturing system according to an embodiment.

FIGS. 4A and 4B are views illustrating examples of caption information.

FIGS. 5A and 5B are views illustrating examples of caption information.

FIG. 6 is a flowchart of processing performed by a manually controlled camera in one embodiment.

FIG. 7 is a flowchart of processing performed by an automatically controlled camera in one embodiment.

FIG. 8 is a view illustrating a functional configuration example of a type determination unit.

FIG. 9 is a flowchart of video cutting determination processing.

FIG. 10 is a view illustrating an example of relevance predictive information.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

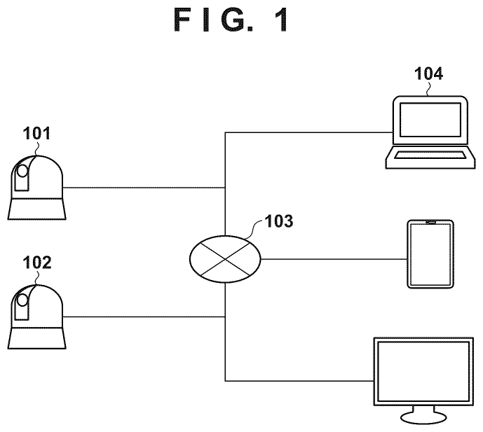

An example of a configuration of an image capturing system according to an embodiment will be described with reference to FIG. 1. The image capturing system according to the present embodiment can be used for video production. The image capturing system according to the present embodiment can realize three types of video cutting: element match cut, action match cut, and insert cut, which will be described later.

The image capturing system according to the present embodiment includes a first image capturing device and a second image capturing device. The first image capturing device and the second image capturing device are used for capturing a plurality of viewpoint images. The first image capturing device and the second image capturing device are each capable of changing an angle of view. For example, the first image capturing device and the second image capturing device may have pan, tilt, and zoom mechanisms.

In one embodiment, the first image capturing device is a manually controlled camera 101 which is controlled manually. For example, the operator can control the manually controlled camera 101 via an operation input device 104. Specifically, the operator can specify an angle of view of the manually controlled camera 101. In this case, the manually controlled camera 101 acquires video of the angle of view designated by the operator. However, the angle of view of the manually controlled camera 101 may be changed by a force exerted by the operator on the manually controlled camera 101. In addition, the first image capturing device may be automatically controlled.

In one embodiment, the second image capturing device is an automatically controlled camera 102, which is controlled automatically. The automatically controlled camera 102 can automatically determine the angle of view as described below. That is, the automatically controlled camera 102 can receive a result of analyzing video captured by the manually controlled camera 101. In addition, the automatically controlled camera 102 can perform angle-of-view control so as to obtain a video having a relevance to the video captured by the manually controlled camera 101 in accordance with the analysis result. However, it is not essential that the second image capturing device be automatically controlled. For example, the angle of view of the second image capturing device may be manually controlled.

The image capturing system according to the present embodiment may further include the operation input device 104. The operation input device 104 is a terminal used by an operator to control the image capturing system. The operation input device 104 may be an input device such as a controller, or an information processing device such as a personal computer, a smartphone, or a tablet terminal, for example. The operation input device 104 can perform control to change the angle-of-view of the camera. For example, the operation input device 104 can transmit a control signal to the manually controlled camera 101 in accordance with an operation performed by an operator. At this time, the manually controlled camera 101 can change the angle of view in accordance with the control signal.

Further, the operation input device 104 can perform switching control. Switching refers to switching of video. For example, the switching may be switching between videos to be distributed or recorded. In the present embodiment, the operation input device 104 can switch between the video captured by the manually controlled camera 101 and the video captured by the automatically controlled camera 102. In this specification, switching from the video captured by the manually controlled camera 101 to the video captured by the automatically controlled camera 102 may be referred to as switching from the manually controlled camera 101 to the automatically controlled camera 102. In one embodiment, the operation input device 104 may distribute the video from the camera selected by the switching control to outside of the image capturing system. Also, in another embodiment, the operation input device 104 may store the video from the camera selected by the switching control, or store the video to a storage device outside of the image capturing system.

The manually controlled camera 101 can transmit a result of analyzing captured video to the automatically controlled camera 102 via a network 103. The automatically controlled camera 102 changes the angle of view of the automatically controlled camera 102 based on the result of analyzing the video captured by the manually controlled camera 101 so as to be able to capture video that does not feel unnatural when the camera is switched to the automatically controlled camera 102. Note that the angle of view of the automatically controlled camera 102 may be changed only when the angle of view of the manually controlled camera 101 is changed, or when there is a change in the video captured by the manually controlled camera 101 due to the movement of a subject or the like.

The manually controlled camera 101, the automatically controlled camera 102, and the operation input device 104 are connected via the network 103. The type of the network 103 is not particularly limited, and may be, for example, a wired network or a wireless network. The network 103 may also be a local area network (LAN) or the Internet.

FIG. 1 illustrates a main configuration of an image capturing system according to the present embodiment. That is, the image capturing system may include additional devices not illustrated. For example, more cameras may be connected to the network 103. In addition, a server device, other than the operation input device 104, which is connected to the network 103 may have a server function for distributing video via the network 103 or a function for holding video.

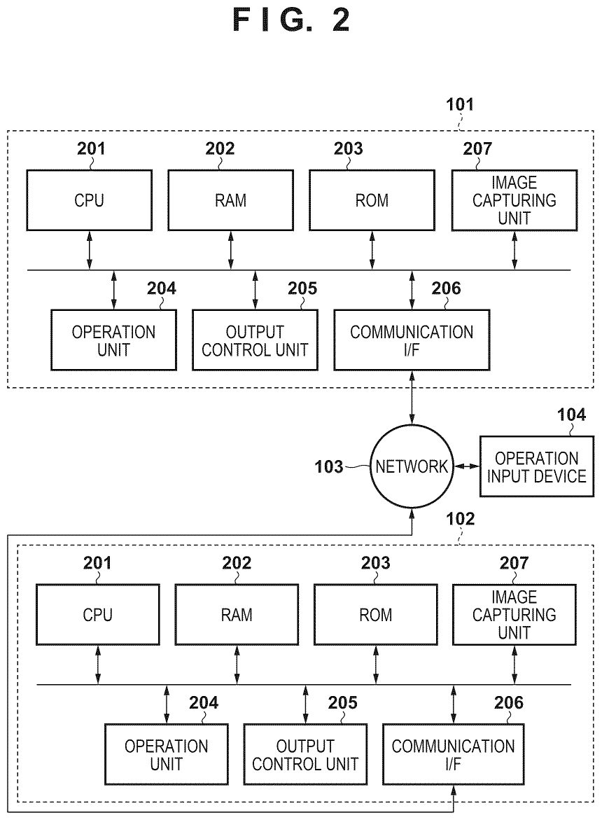

FIG. 2 illustrates a hardware configuration example of the manually controlled camera 101 and/or the automatically controlled camera 102. In the present embodiment, the manually controlled camera 101 and the automatically controlled camera 102 have the same hardware configuration, and behave in the same manner unless otherwise specifically described. However, the manually controlled camera 101 and the automatically controlled camera 102 may have different hardware configurations.

The manually controlled camera 101 and the automatically controlled camera 102 include a CPU 201, a RAM 202, a ROM 203, an operation unit 204, an output control unit 205, a communication I/F 206, and an image capturing unit 207.

The ROM 203 is a memory that stores a boot program executed by the CPU 201 when the manually controlled camera 101 or the automatically controlled camera 102 is activated, an instruction program for executing respective processes, and data used by these programs and the like. The ROM 203 may be a readable/writable medium such as a hard disk drive (HDD) or a solid state drive (SSD).

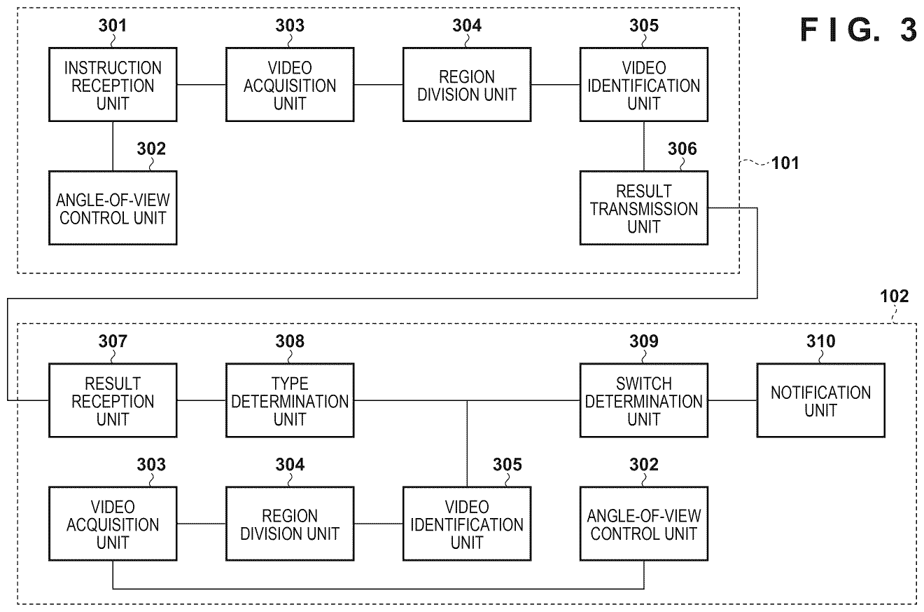

The CPU 201 controls a motor for changing the angle of view connected to the manually controlled camera 101 or the automatically controlled camera 102 via the output control unit 205. In the present embodiment, pan, tilt, and zoom (hereinafter, PTZ) control of the manually controlled camera 101 and the automatically controlled camera 102 is performed. The CPU 201 also acquires data via the operation unit 204. The operation unit 204 may process a signal received from the operation input device 104 or the like via the communication I/F 206 and transmit data indicating the processing result to the CPU 201. In addition, the CPU 201 can output the data generated by the process to another device via the output control unit 205. The CPU 201 realizes functions illustrated in FIG. 3 and other camera functions by executing a program loaded into the RAM 202.

The communication I/F 206 receives data from other devices via the network 103 and sends the received data to the CPU 201. In addition, the communication I/F 206 transmits the data generated by the CPU 201 to another device via the network 103. In addition, the automatically controlled camera 102 acquires a result of analyzing video generated by the manually controlled camera 101 via the communication I/F 206 and stores it in the RAM 202.

The image capturing unit 207 captures video in accordance with an angle of view controlled by the output control unit 205. The image capturing unit 207 of the manually controlled camera 101 captures a first video. The image capturing unit 207 of the automatically controlled camera 102 captures a second video. The image capturing unit 207 may include an optical system including an image sensor, a lens, and the like. The video captured by the image capturing unit 207 is stored in the RAM 202. The manually controlled camera 101 and the automatically controlled camera 102 can read video data into the RAM 202 and then perform video analysis or distribution processing.

The CPU 201 can load the program as described above from the ROM 203 into the RAM 202. The CPU 201 can then execute the program loaded into the RAM 202. Meanwhile, these programs may be acquired from another device via the communication I/F 206.

FIG. 3 illustrates a functional configuration example of the manually controlled camera 101 and/or the automatically controlled camera 102. Hereinafter, processing performed by the manually controlled camera 101 and the automatically controlled camera 102 at the time of video capturing will be described. In the following description, each functional unit illustrated in FIG. 3 is the performer of the processing. In the present embodiment, the processing of each of the functional units is realized by the CPU 201 executing a computer program. However, at least a part of the respective functional units illustrated in FIG. 3 may be implemented by hardware.

The manually controlled camera 101 includes an instruction reception unit 301, an angle-of-view control unit 302, a video acquisition unit 303, a region division unit 304, a video identification unit 305, and a result transmission unit 306. The automatically controlled camera 102 includes a result reception unit 307, a type determination unit 308, a switch determination unit 309, a notification unit 310, the video acquisition unit 303, the region division unit 304, the video identification unit 305, and the angle-of-view control unit 302.

The instruction reception unit 301 acquires a control instruction from the operation input device 104. The control instruction may include information for controlling an angle of view of the manually controlled camera 101. The information for controlling the angle of view may be, for example, information specifying a pan, tilt, or zoom position, or information indicating the amount of change in the pan, tilt, or zoom position. Hereinafter, such information is referred to as PTZ control information. The instruction reception unit 301 transmits PTZ control information to the angle-of-view control unit 302 in accordance with the acquired control instruction.

The angle-of-view control unit 302 changes the angle of view of the camera. The angle-of-view control unit 302 can change the angle of view by controlling hardware such as a motor mounted on the camera. For example, the angle-of-view control unit 302 can control panning, tilting, and zooming of the camera. The angle-of-view control unit 302 can perform such control in accordance with PTZ control information. Further, the angle-of-view control unit 302 may electronically realize PTZ control by cutting out a part of the video. For example, the angle-of-view control unit 302 can use electronic zoom.

The angle-of-view control unit 302 of the manually controlled camera 101 can change the angle of view of the manually controlled camera 101 in accordance with a signal received from the instruction reception unit 301. The angle-of-view control unit 302 of the automatically controlled camera 102 can change the angle of view of the automatically controlled camera 102 in accordance with a preset algorithm. For example, the angle-of-view control unit 302 of the automatically controlled camera 102 can change the angle of view of the automatically controlled camera 102 so as to cycle through a capturable range. The angle-of-view control unit 302 of the automatically controlled camera 102 may continuously change the angle of view of the automatically controlled camera 102. By such control, the angle-of-view control unit 302 can search for an angle of view of the automatically controlled camera 102 such that the manually controlled camera 101 can be switched to the automatically controlled camera 102.

The video acquisition unit 303 converts an electric signal acquired by the image capturing unit 207 in an image capturing operation into image data. Then, the video acquisition unit 303 stores the acquired image data in the RAM 202 of the respective cameras.

The region division unit 304 and the video identification unit 305 identify content of a video. In the present embodiment, the region division unit 304 and the video identification unit 305 included in the manually controlled camera 101 identify content of a first video captured by the manually controlled camera 101. Also, the region division unit 304 and the video identification unit 305 included in the automatically controlled camera 102 identify content of a second video captured by the automatically controlled camera 102.

In the present embodiment, the region division unit 304 performs region division processing on captured video. The region division unit 304 may divide the video into regions in accordance with a position of an object in the video. For example, the region division unit 304 can perform region division for each object based on an object detection result. For example, the region division unit 304 may perform processing for classifying an object in video held in the RAM 202 on a pixel-by-pixel basis. The region division unit 304 may detect and recognize an object in video by image recognition using a neural network. Also, the region division unit 304 can perform region division for each object in accordance with a classification result. The region division unit 304 can perform such region division processing (hereinafter, sometimes referred to as segmentation processing) for each frame of the video. However, the method of the segmentation processing is not particularly limited. For example, the region division unit 304 may divide a region into a plurality of rectangular regions having the same size. Further, in the present embodiment, it is not essential that the region division unit 304 performs segmentation processing. In this case, the video identification unit 305, which will be described later, may perform captioning processing on the entire first video.

Further, the region division unit 304 can identify the presence or absence of a main subject in the video. In the present embodiment, the region division unit 304 can determine whether or not a main subject such as a person or an object is present in each divided region according to the classification result described above. In the present embodiment, a main subject is different from a landscape or a uniform texture. The method for determining the presence of a main subject is not particularly limited. For example, the region division unit 304 may determine a main subject based on a position, size, or semantic information of a candidate object in the input image. As a specific example, the region division unit 304 can detect an object of a specific type as a main subject. As another example, the region division unit 304 may detect an object that is of a specific type and occupies a region larger than a threshold as a main subject. Further, the region division unit 304 may determine a main subject based on distribution characteristics of the respective pixels of the input image. When a main subject is present in a respective region, the region division unit 304 can record information indicating the presence of a main subject.

The region division unit 304 may record the result of the segmentation processing (hereinafter, may be referred to as segmentation information) in the RAM 202. The segmentation information includes a pair of ID information capable of uniquely identifying a region and information indicating the presence or absence of a main subject in the region.

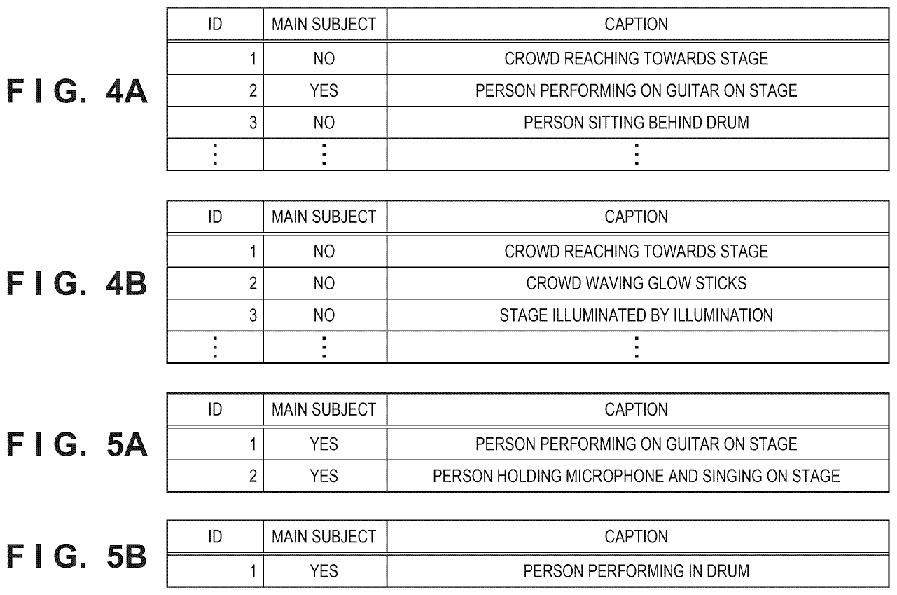

The video identification unit 305 performs processing for identifying an object for each region. In the present embodiment, the video identification unit 305 performs captioning processing for generating a caption describing the video for each region. The captioning processing generates a caption that expresses a name, a feature, an action, or the like of an object included in each region in a sentence. The video identification unit 305 performs captioning processing based on the segmentation information held in the RAM 202. The method of the captioning processing is not particularly limited. For example, the video identification unit 305 may generate a caption based on the result of object recognition by the region division unit 304. In addition, the video identification unit 305 may generate a caption by image recognition using a neural network. Incidentally, in captioning processing using a neural network, an English caption is often generated. However, the video identification unit 305 may generate a Japanese caption, as described below with reference to FIGS. 4A and 4B. Thus, the language of the caption is not limited. The video identification unit 305 may perform captioning processing in accordance with the methods described in Japanese Patent Laid-Open No. 2023-128088, Japanese Patent Laid-Open No. 2022-135518, Japanese Patent Laid-Open No. 2021-117860, or Japanese Patent Laid-Open No. 2020-512759.

The video identification unit 305 may record the result of captioning processing (hereinafter, may be referred to as caption information) in the RAM 202. The caption information includes ID information of a region included in the segmentation information, information indicating the presence or absence of a main subject, and a set of captions.

As described above, the video identification unit 305 may identify the content of the video. The identification result is indicated by the caption information described above. For example, the caption may indicate the name (e.g., Mr. A and Mr. B) or type (e.g., person) of the object in the video. The caption may also indicate an action (e.g., a performance, etc.) of an object in the video. In this manner, the video identification unit 305 may identify an object in the video and an action of an object in the video. However, in the present disclosure, it is not essential to perform the captioning processing. For example, the video identification unit 305 may identify an object in a video and an action of an object in a video by image recognition using a neural network. In one embodiment, the result transmission unit 306, which will be described later, transmits information indicating a result of such an identification to the automatically controlled camera 102 instead of the caption information.

The result transmission unit 306 of the manually controlled camera 101 acquires information (caption information in this example) indicating a result of identifying content of the first video generated by the video identification unit 305 from the RAM 202, and transmits the information to the automatically controlled camera 102. The result reception unit 307 of the automatically controlled camera 102 receives the information (caption information in this example) indicating the result of identifying content of the first video transmitted from the manually controlled camera 101, and records the information in the RAM 202.

The type determination unit 308 selects a video cutting type in accordance with the result of identifying content of the first video captured by the manually controlled camera 101. The video cutting type indicates a relationship between the videos when the video is switched from the first video captured by the manually controlled camera 101. In the present embodiment, the type determination unit 308 selects a video cutting type that can be performed when switching from the manually controlled camera 101 to the automatically controlled camera 102. The type determination unit 308 may select a video cutting type based on at least one of an object appearing in the first video, an action of an object appearing in the first video, and the presence or absence of a main subject in the first video.

In the present embodiment, the type determination unit 308 acquires caption information transmitted from the manually controlled camera 101 indicating the result of identifying content of the first video. Then, the type determination unit 308 selects the video cutting type based on the caption information. The type determination unit 308 can select the video cutting type by extracting a characteristic element or action from the video based on a caption included in the caption information and information indicating the presence or absence of a main subject. A specific method for determining the video cutting type will be described later.

The switch determination unit 309 determines whether or not the result of identifying content of the second video captured by the automatically controlled camera 102 satisfies a switching condition corresponding to the video cutting type selected by the type determination unit 308. In the present embodiment, the switch determination unit 309 determines whether or not the result of identifying content of the second video satisfies the condition based on the identification result of the first video in addition to the video cutting type determined by the type determination unit 308. Then, the switch determination unit 309 determines that the first video can be switched to the second video based on the result of the determination that this condition is satisfied. By the method described below, the switch determination unit 309 can determine that the first video can be switched to the second video in a case where the first video is connected to the second video without giving the viewer a sense of unnaturalness.

In the present embodiment, the switch determination unit 309 determines whether or not the second video satisfies a condition corresponding to the video cutting type, based on the caption information for each of the first video and the second video. In the following example, the switch determination unit 309 performs this determination based on relevance predictive information generated based on the caption information for the first video and the caption information for the second video. Specific conditions will be described later.

As described above, the angle-of-view control unit 302 of the automatically controlled camera 102 can control the angle of view of the automatically controlled camera 102 so as to cycle through a capturable range. For example, the angle-of-view control unit 302 can continuously (e.g., continuously or intermittently) change the angle of view of the automatically controlled camera 102 before the switch determination unit 309 determines that the first video can be switched to the second video. Meanwhile, the angle-of-view control unit 302 can stop changing the angle of view of the automatically controlled camera 102 in response to the switch determination unit 309 determining that the first video can be switched to the second video. As a result, the angle of view of the automatically controlled camera 102 is controlled such that it is possible to switch from the first video to the second video according to the video cutting type. As described above, the angle-of-view control unit 302 of the automatically controlled camera 102 can determine the angle of view of the automatically controlled camera 102 in accordance with the determination result by the switch determination unit 309.

The notification unit 310 makes a notification that the first video can be switched to the second video in response to the switch determination unit 309 determining that the first video can be switched to the second video. For example, the notification unit 310 can notify the operation input device 104. The operator of the switching can confirm the notification and then perform the switching. The notification unit 310 may transmit a notification to the manually controlled camera 101 or another device connected via the network 103. The notification unit 310 may notify a device external to the image capturing system. As described above, the notification unit 310 can notify that the angle of view change of the automatically controlled camera 102 is completed such that it is possible to switch from the manually controlled camera 101 to the automatically controlled camera 102 by any method that can be understood by the switching operator.

The functional configuration of the image capturing system is not limited to that illustrated in FIG. 3. In the example illustrated in FIG. 3, the respective functional units are arranged to be distributed among the manually controlled camera 101 and the automatically controlled camera 102. However, for example, the manually controlled camera 101 may include the type determination unit 308 instead of the automatically controlled camera 102. Further, the region division unit 304 and the video identification unit 305 of the automatically controlled camera 102 may generate caption information about the first video. In this case, the manually controlled camera 101 does not need to include the region division unit 304 and the video identification unit 305. Further, the operation input device 104 may have functional units for determining whether switching is possible, such as the region division unit 304, the video identification unit 305, the type determination unit 308, the switch determination unit 309, and the notification unit 310, and may function as an image capturing control device. Such an operation input device 104 can be realized by a computer comprising a processor and a memory. That is, the processor can realize the functions of the respective units by executing a program stored in the memory.

FIGS. 4A to 4B and FIGS. 5A to 5B illustrate exemplary caption information generated by the video identification unit 305 based on the segmentation information generated by the region division unit 304. FIGS. 4A and 4B and FIGS. 5A and 5B each illustrate caption information generated for a specific frame of the video. As illustrated in FIGS. 4A and 4B and FIGS. 5A and 5B, the caption information includes region ID information, information indicating the presence or absence of a main subject, and a caption.

First, referring to FIGS. 4A and 4B, an exemplary method of selecting a video cutting type will be described. In the present embodiment, the video cutting type includes an element match cut, an action match cut, and an insert cut.

The element match cut is a “match cut” based on an element, and is a method for connecting video such that there are the same object, or objects of the same type, in the video both before and after switching. In the element match cut, for example, the switching is performed such that there are constituent elements or objects of the same type in the video before and after the switching. Therefore, when a predetermined object is detected from the first video, the type determination unit 308 can select element match cut as the video cutting type. Here, the predetermined object may be any type of object or may be an object of a specific type. The predetermined object may be an object determined to be a main subject. As a specific example, when the video before switching includes a musical instrument as a main subject, the video after switching can also include a musical instrument as a main subject. In this case, since there is a relevance in the videos before and after the switching, it is possible to reduce the sense of unnaturalness of the viewer due to the switching.

An action match cut is also called an “action cut” or “cutting on action”, and is a way of connecting videos such that there is the same action of an object in the video both before and after switching. In the action match cut, for example, switching is performed while a plurality of cameras capture the same action of a moving object. Therefore, when a predetermined action is detected from the first video, the type determination unit 308 can select action match cut as the video cutting type. Here, the predetermined action may be any type of action or may be an action of a specific type. Also, the action may include behaviors and movements of an object. The action match cut also allows the video to be connected semantically. Therefore, it is possible to reduce the sense of unnaturalness of the viewer due to the switching.

The insert cut is a method of connecting video so that a main subject is not present in the video before switching and a main subject is not present the video after switching. For example, in a case where a main subject is not detected from the first video, the type determination unit 308 can select an insert cut as the video cutting type. When an insert cut is performed, the automatically controlled camera 102 captures an insert video in which a main subject does not exist. By the insert cut, the video can be connected so as not to cause a change in a main subject. Therefore, it is possible to reduce the sense of unnaturalness of the viewer due to the switching.

As described above, in the present embodiment, the type determination unit 308 selects the video cutting type based on caption information indicating the result of identifying content of the video. Hereinafter, a method of selecting a video cutting type based on caption information will be described.

FIG. 4A illustrates an example of caption information generated by the video identification unit 305 of the manually controlled camera 101. The type determination unit 308 may determine the video cutting type based on a word or a sentence included in a caption describing the first video. In the present embodiment, the type determination unit 308 can select a video cutting type that can be performed, by specifying a part of speech of a caption.

For example, if a caption includes a noun, as does the caption of an ID 1, the video may be connected such that an object indicated by the noun is in both videos. Therefore, in this case, the type determination unit 308 can determine that an element match cut can be performed. Also, if a caption includes a verb, as does the caption of an ID 1, the video may be connected such that an action indicated by the verb is in both videos. Therefore, in this case, the type determination unit 308 can determine that an action match cut can be performed. When the caption includes a verb indicating an action, the type determination unit 308 may determine that the action match cut can be performed.

Note that the type determination unit 308 may select two or more video cutting types. For example, in the exemplary embodiment illustrated in FIG. 4A, the video identification unit 305 may determine that an element match cut and an action match cut can be performed.

FIG. 4B illustrates an example of caption information generated by the video identification unit 305 of the manually controlled camera 101. In an embodiment, the video identification unit 305 may determine that the insert cut can be performed in a case where a main subject is not present in any region. In an example illustrated in FIG. 4B, the video identification unit 305 may determine that an insert cut can be performed.

In the present embodiment, the region division unit 304 determines the presence or absence of a main subject for each region. Meanwhile, the video identification unit 305 may determine the presence or absence of a main subject based on a caption. For example, a case where a main subject does not exist may be a case where a caption does not include a common or proper noun representing a person. That is, when the caption includes only a collective noun or a common noun representing an object or the like, it can be determined that a main subject does not exist. As another example, a word representing a main subject may be registered in advance with the automatically controlled camera 102. In this case, when a caption does not include a registered word, the video identification unit 305 can determine that a main subject is not present.

The video identification unit 305 may select a single video cutting type. However, in the above-described determination based on the caption, the conditions for each of the plurality of video cutting types may be satisfied. In such a case, the video identification unit 305 may determine that all video cutting types satisfying the conditions can be performed. It is also conceivable that for all video cutting types, the conditions are not satisfied. In such cases, the video identification unit 305 may avoid selecting a single video cutting type. Furthermore, the video cutting types are not particularly limited. That is, the selectable video cutting types may include video cutting types other than the element match cut, the action match cut, and the insert cut. In addition, the number of selectable video cutting types may be one, two, or more.

Next, exemplary processing performed by the type determination unit 308 and the switch determination unit 309 will be described referring to FIGS. 5A to 5B. FIG. 5A illustrates an example of caption information generated by the video identification unit 305 of the manually controlled camera 101. Also, FIG. 5B illustrates exemplary caption information generated by the video identification unit 305 of the automatically controlled camera 102 during an angle-of-view search of the automatically controlled camera 102. As described above, when caption information as illustrated in FIG. 5A is received from the manually controlled camera 101, the type determination unit 308 selects a video cutting type that can be performed based on the caption information. In this example, since the caption includes common nouns such as “stage” and “guitar”, the type determination unit 308 determines that an element match cut can be performed. Also, since the caption includes a verb such as “performing”, the type determination unit 308 determines that an action match cut can be performed.

At this time, the type determination unit 308 may combine information referred to for determining that an element match cut or an action match cut can be performed with information indicating a video cutting type and record the information in the RAM 202. This information is referred to in this specification as relevance predictive information. The type determination unit 308 may generate the relevance predictive information based on a word or a sentence included in a caption describing the first video. For example, the type determination unit 308 may record a word or a sentence that is a cause for selecting (reason for determining) the video cutting type. This relevance predictive information indicates a word or sentence that a caption describing the second video should include for the switching condition to be satisfied. Therefore, the relevance predictive information can be used as a condition of an angle of view that should be captured by the automatically controlled camera 102.

For example, the type determination unit 308 can record nouns (for example, the above-described “stage” and “guitar”) included in the caption generated by the video identification unit 305 in a pair with information indicating an element match cut. In addition, the type determination unit 308 can record verbs included in the caption (for example, the above-described “performing”) in a pair with information indicating an action match cut.

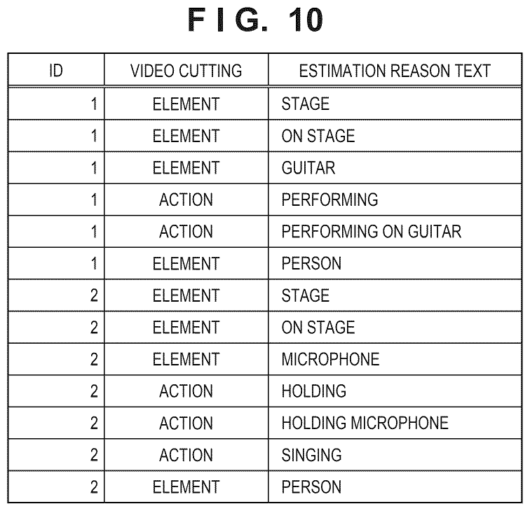

FIG. 10 illustrates an exemplary relevance predictive information recorded in the RAM 202 by the type determination unit 308. The relevance predictive information includes a region ID, a video cutting type determined by the type determination unit 308, and estimation reason text. The estimation reason text is a word or a sentence that is a reason for determining the video cutting type.

In the present embodiment, the automatically controlled camera 102 captures video while changing the angle of view of the automatically controlled camera 102 so as to cycle through the capturable range. The video identification unit 305 of the automatically controlled camera 102 generates caption information as illustrated in FIG. 5B for the video captured by the automatically controlled camera 102.

The switch determination unit 309 determines whether or not a switching condition is satisfied by comparing a word or sentence included in a caption describing the first video with a word or sentence included in a caption describing the second video. In the present embodiment, the switch determination unit 309 acquires, from the RAM 202, the relevance predictive information generated by the type determination unit 308 based on caption information acquired from the manually controlled camera 101. Then, the video identification unit 305 performs processing for comparing caption information generated based on the video captured by the automatically controlled camera 102 and the relevance predictive information. For example, the switch determination unit 309 can analyze caption information generated by the video identification unit 305. Specifically, a sentence or word such as a common noun, a proper noun, or a verb that matches a pair of the video cutting type indicated by the relevance predictive information and estimation reason text can be searched for in a caption.

For example, in a case where the relevance predictive information indicates an element match cut, the switching condition may include that an object detected from the first video or an object related to an object is detected from the second video. To this end, the switch determination unit 309 can search for a noun that matches the estimation reason text in a caption generated based on video captured by the automatically controlled camera 102. Here, the case where an object related to an object detected from the first video is detected from the second video includes a case where the object detected from the first video and the object detected from the second video have a common attribute. For example, when the estimation reason text and a word included in the caption have a common attribute, the switch determination unit 309 may determine that an element match cut can be performed. For example, “guitar”, “microphone”, and “drum” are not identical words, but they have the common attribute of being musical instruments. According to such a configuration, it can be determined that switching is possible in a case where there are the same object, or objects of the same type, both in the first video and the second video. Also, when the estimation reason text and a word included in the caption have a conceptually inclusive relationship, the switch determination unit 309 may determine that an element match cut can be performed. Such determination can be performed, for example, by referring to dictionary data, prepared in advance, which indicates attributes or inclusion relationships of words.

Also, in a case where the relevance predictive information indicates an action match cut, the switching condition may include that an action detected from the first video or an action related to an action is detected from the second video. To this end, the switch determination unit 309 can search for a verb that matches the estimation reason text in a caption generated based on video captured by the automatically controlled camera 102. Here, the case where an action related to an action detected from the first video is detected from the second video includes a case where the action detected from the first video and the action detected from the second video have a common attribute. Also, when the estimation reason text and a word included in the caption have a conceptually inclusive relationship, the switch determination unit 309 may determine that an action match cut can be performed. For example, in a case where the caption includes a word indicating an action encompassed by “performing” such as “singing”, the switch determination unit 309 may determine that the action match cut can be performed.

In this example, the switch determination unit 309 can search for text that matches the estimation reason text in a caption generated based on video captured by the automatically controlled camera 102 to determine whether to the video is connected. On the other hand, the switch determination unit 309 may compare a word or a sentence in a caption generated based on video captured by the manually controlled camera 101 and a caption generated based on video captured by the automatically controlled camera 102.

The caption of ID 1 illustrated in FIG. 5A and the caption of ID 1 illustrated in FIG. 5B include the same verb “performing”. For this reason, the switch determination unit 309 can find the verb “performing” that matches the pair of “action match cut” and “performing” included in the relevance predictive information illustrated in FIG. 10 from the caption of ID 1 illustrated in FIG. 5B. In this case, it is possible to switch from the manually controlled camera 101 to the automatically controlled camera 102 without unnaturalness due to the action match cut. Therefore, the switch determination unit 309 can determine that switching from the manually controlled camera 101 to the automatically controlled camera 102 is possible. At this time, the switch determination unit 309 may record, in the RAM 202, a combination of the angle of view of the automatically controlled camera 102 when the video corresponding to the caption is captured and caption information.

As a method of analyzing and comparing captions, a method different from a method of specifying parts of speech may be used. For example, when information representing a location, such as “on stage”, matches, the switch determination unit 309 may determine that an element match cut can be performed.

On the other hand, when the relevance predictive information indicates an insert cut, the switching condition may include that a main subject is not detected from the second video. For this purpose, the switch determination unit 309 determines whether caption information generated based on the video captured by the automatically controlled camera 102 indicates that a main subject is not present. When a main subject is not present in the video captured by the automatically controlled camera 102, the switch determination unit 309 can determine that an insert cut can be performed.

Note that, in the present embodiment, a main subject is not included in the video after the switching by an insert cut. Therefore, in a case where the relevance predictive information includes an insert cut and the region division unit 304 determines that a main subject is present in the second video, it is possible to skip caption generation and comparison processing for the second video captured at this angle of view. Also, in many cases, a main subject is included in the video after switching by an element match cut or action match cut. Therefore, as illustrated in FIG. 10, in a case where the relevance predictive information does not include an insert cut and the region division unit 304 determines that a main subject is not present in the second video, similarly, processing for the second video captured at this angle of view can be skipped. In this way, it is possible to improve the efficiency of the search processing by limiting the angles of view of the second video to be processed based on the video cutting type included in the relevance predictive information.

In the present embodiment, the caption information may include captions for each of a plurality of regions. The switch determination unit 309 may determine that an element match cut can be performed when there are nouns in one of the captions for the first video and one of the captions for the second video that correspond to each other. The same applies for the action match cut.

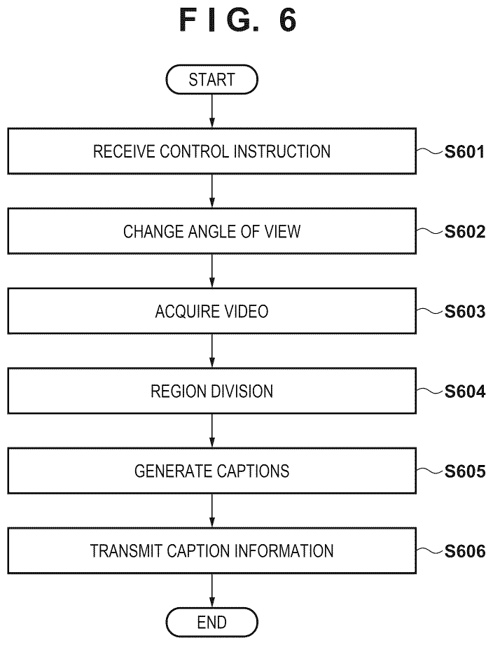

Processing performed by the manually controlled camera 101 in the image capturing control method according to the embodiment will be described with reference to the flowchart of FIG. 6. During image capturing by the manually controlled camera 101, the processing of step S601 to step S606 is repeated. Note that the start and end of image capturing by the manually controlled camera 101 and the automatically controlled camera 102 may be performed in synchronization with the start of recording or switching of the respective cameras, or an instruction to start or end recording from the operation input device 104.

In step S601, the instruction reception unit 301 receives a control instruction from the operation input device 104. Further, the instruction reception unit 301 outputs a signal for angle-of-view control to the angle-of-view control unit 302. In step S602, the angle-of-view control unit 302 performs a change of angle of view of the manually controlled camera 101 in accordance with a signal acquired from the instruction reception unit 301. When an instruction to change the angle of view is not inputted, the manually controlled camera 101 performs image capturing without changing the angle of view.

In step S603, the video acquisition unit 303 acquires video obtained by an image capturing operation of the manually controlled camera 101, and outputs the video to the region division unit 304. The video acquisition unit 303 may output the video to the region division unit 304 regardless of the angle-of-view changing operation. For example, the video acquisition unit 303 may continuously output video to the region division unit 304 before the change of the angle of view is executed and during the change of the angle of view. However, in order to reduce the processing load, the video acquisition unit 303 may output the video to the region division unit 304 after the change in angle of view is completed. In this case, during the operation of changing the angle of view of the manually controlled camera 101, it is possible to omit the video output to the region division unit 304.

In step S604, the region division unit 304 performs segmentation processing on the video as described above. The region division unit 304 records the segmentation information in the RAM 202. In step S605, the video identification unit 305 generates a caption for each region based on the segmentation information, as described above. Then, the video identification unit 305 records the caption information in the RAM 202.

In step S606, the result transmission unit 306 transmits the caption information to the automatically controlled camera 102. The result transmission unit 306 may transmit the caption information via the network 103. However, the communication method between the manually controlled camera 101 and the automatically controlled camera 102 is not limited.

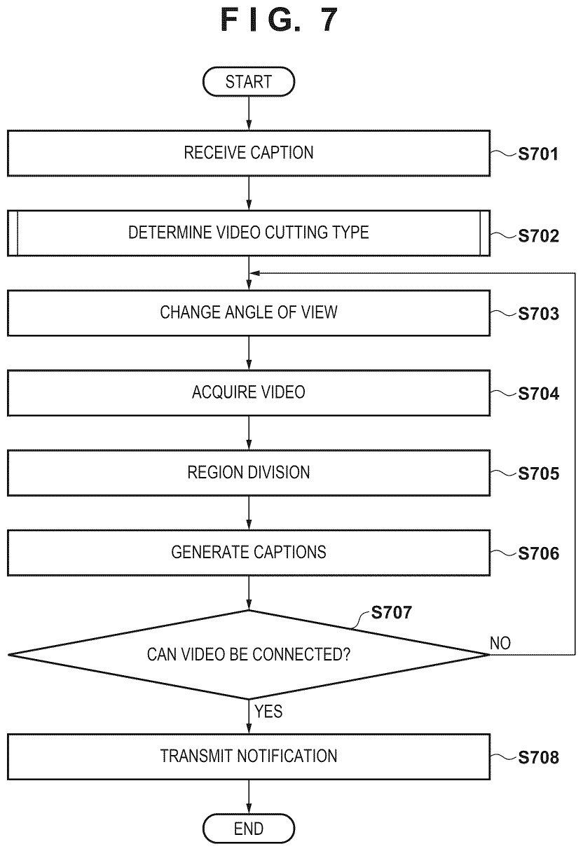

Processing performed by the automatically controlled camera 102 in the image capturing control method according to the embodiment will be described with reference to the flowchart of FIG. 7. In accordance with this flowchart, the automatically controlled camera 102 can perform an angle-of-view search. The process illustrated in FIG. 7 can be started when the automatically controlled camera 102 receives caption information from the manually controlled camera 101.

In step S701, the result reception unit 307 receives caption information transmitted from the manually controlled camera 101 and records the caption information in the RAM 202.

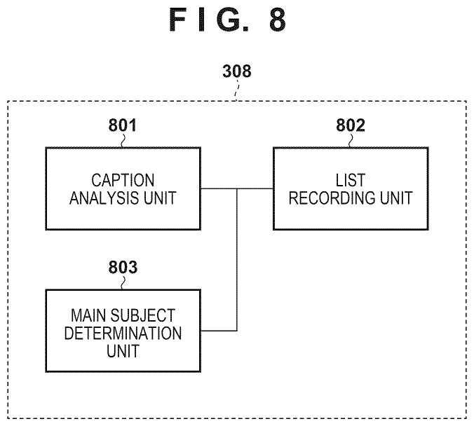

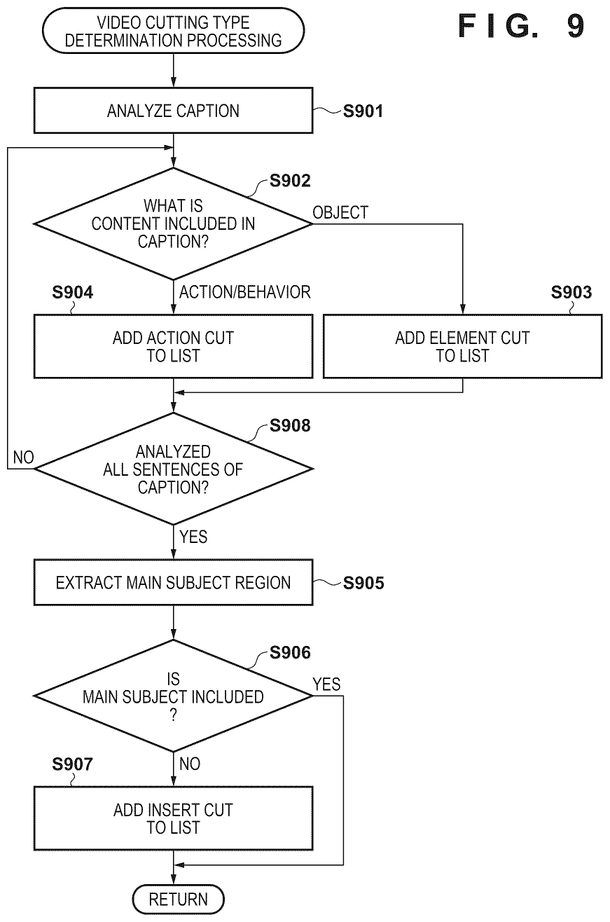

In step S702, the type determination unit 308 selects the video cutting type based on the received caption information, and records the determination result in the RAM 202. The processing of step S702 will be described later referring to FIG. 8 and FIG. 9.

In step S703, the angle-of-view control unit 302 changes the angle of view of the automatically controlled camera 102. The angle-of-view control unit 302 sequentially changes the angle of view of the automatically controlled camera 102 so as to cover a capturable range. In this way, the automatically controlled camera 102 can cycle through the capturable range. In order to shorten the cycling time, the cycling may be performed after the zoom value is changed so that the angle of view is the widest angle.

In step S704, the video acquisition unit 303 acquires video captured by the automatically controlled camera 102, and outputs the video to the region division unit 304. Similarly to in step S603, the video acquisition unit 303 may output the video to the region division unit 304 regardless of the angle-of-view changing operation. However, in order to reduce the processing load, the video acquisition unit 303 may output the video to the region division unit 304 after the change in angle of view is completed.

In step S705, the region division unit 304 performs segmentation processing on the video as described above, and records the segmentation information in the RAM 202. In step S706, the video identification unit 305 generates a caption for each region based on the segmentation information, as described above, and records the caption information in the RAM 202.

In step S707, the switch determination unit 309 determines whether or not the video captured by the manually controlled camera 101 and the video captured by the automatically controlled camera 102 can be connected as described above. When the switch determination unit 309 determines that the videos are connected, the processing proceeds to step S708. Otherwise, the processing returns to step S703. In this case, the angle of view of the automatically controlled camera 102 is changed, and once again it is determined whether or not the video can be connected. In a case where the automatically controlled camera 102 has received new caption information from the manually controlled camera 101, the processing may return to step S701.

In step S708, the switch determination unit 309 transmits to the notification unit 310 a notification indicating that switching from the manually controlled camera 101 to the automatically controlled camera 102 is possible. Further, the notification unit 310 transmits to the operation input device 104 a notification indicating that control of the angle of view of the automatically controlled camera 102 has been completed such that the videos of the automatically controlled camera 102 and the manually controlled camera 101 have a relevance.

Exemplary processing of the type determination unit 308 in step S702 will be described referring to the flowchart of FIG. 9. FIG. 8 illustrates a logical configuration of the type determination unit 308. At the beginning of this processing, relevance predictive information stored in the RAM 202 is initialized.

In step S901, a caption analysis unit 801 performs morphological analysis on one of the captions included in the caption information acquired from the manually controlled camera 101.

In step S902, the caption analysis unit 801 determines whether or not a noun representing an object is included in the caption, and whether or not a verb representing a behavior or an action is included in the caption. When the caption analysis unit 801 determines that the caption includes a noun representing an object, the processing proceeds to step S903. When the caption analysis unit 801 determines that the caption includes a verb representing a behavior or an action, the processing proceeds to step S904.

In step S903, a list recording unit 802 adds a pair of a video cutting type indicating an element match cut and a noun representing an object detected from the caption to the relevance predictive information held by the RAM 202. In step S904, the list recording unit 802 adds a pair of a video cutting type indicating an action match cut and a verb representing a behavior or an action detected from the caption to the relevance predictive information held by the RAM 202.

In step S905, the caption analysis unit 801 determines whether analysis of all captions has been completed. If there remain captions that have not been analyzed, the processing returns to step S902. By looping through step S902 to step S905, the captions of the respective regions are analyzed. Note that one caption may include a plurality of nouns each representing an object. Also, one caption may include a plurality of verbs each representing a behavior or an action. Also, one caption may include both a noun representing an object and a verb representing a behavior or an action. In these cases, the list recording unit 802 can add a plurality of pairs of the video cutting type and the estimation reason text to the relevance predictive information.

In step S906, a main subject determination unit 803 refers to information indicating the presence or absence of a main subject in the respective regions included in the caption information. If the presence of a main subject is indicated for any of the regions, the processing of FIG. 9 ends. On the other hand, if the presence of a main subject is not indicated in any of the regions, the processing proceeds to step S907.

In step S907, the list recording unit 802 adds a video cutting type indicating an insert cut to the relevance predictive information held by the RAM 202.

According to the above configuration, it is possible to determine whether or not it will be unnatural when the manually controlled camera 101 is switched to the automatically controlled camera 102 at the current angle of view of the automatically controlled camera 102. Further, in the above-described embodiment, when the switch determination unit 309 determines that switching is possible, changing of the angle of view of the automatically controlled camera 102 is stopped. That is, according to the above-described embodiment, it is possible to automatically search for an angle of view of the automatically controlled camera 102 so that a sense of unnaturalness does not arise due to the switching. On the other hand, it is not essential to search for an angle of view of the automatically controlled camera 102. For example, a second manually controlled camera may be used instead of the automatically controlled camera 102. In this case, the operator of the camera can performing image capturing while changing the angle of view of the second manually controlled camera. In such a case, the switch determination unit 309 can determine whether switching from the manually controlled camera 101 to the second manually controlled camera is possible. Then, the operator can confirm the notification by the notification unit 310 and perform switching. Even with such a configuration, less unnatural video switching becomes easier.

According to a study by the inventor of the present application, when video is switched using a switcher or the like, if there is no relevance between the video before and after the switching, the video feels unnatural. According to an embodiment of the present disclosure, it is possible to, in a technique for switching videos from a plurality of image capturing devices, make less unnatural video switching easier.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-095374, filed Jun. 12, 2024, which is hereby incorporated by reference herein in its entirety.

What is claimed is:

1. A control apparatus comprising:
one or more memories storing instructions; and
one or more processors that execute the instructions to:
identify content of a video;
determine a video cutting type indicating a relationship between videos at a time of switching video from a first video captured by a first image capturing device in accordance with a result of identifying content of the first video;
determine whether a result of identifying content of a second video captured by a second image capturing device satisfies a condition corresponding to the video cutting type, wherein the second image capturing device captures the second video while changing an angle of view; and
determine that the first video can be switched to the second video based on a result of the determination that the condition is satisfied.

2. The control apparatus according to claim 1, wherein the one or more processors execute the instructions to identify a name or type of an object in a video.

3. The control apparatus according to claim 2, wherein the one or more processors execute the instructions to select an element match cut as the video cutting type in a case where a predetermined object is detected from the first video,
wherein a condition corresponding to the element match cut includes that an object detected from the first video or an object related to the object is detected from the second video.

4. The control apparatus according to claim 1, wherein the one or more processors execute the instructions to identify an action of an object in a video.

5. The control apparatus according to claim 4, wherein the one or more processors execute the instructions to select an action match cut as the video cutting type in a case where a predetermined action is detected from the first video,
wherein a condition corresponding to the action match cut includes that an action detected from the first video or an action related to the action is detected from the second video.

6. The control apparatus according to claim 1, wherein the one or more processors execute the instructions to identify a presence or absence of a main subject in a video.

7. The control apparatus according to claim 6, wherein the one or more processors execute the instructions to select an insert cut as the video cutting type in a case where a main subject is not detected from the first video,
wherein a condition corresponding to the insert cut includes a main subject not being detected from the second video.

8. The control apparatus according to claim 1, wherein the one or more processors execute the instructions to perform processing for generating a caption describing a video.

9. The control apparatus according to claim 8, wherein the one or more processors execute the instructions to determine the video cutting type based on a word or sentence which is included in the caption describing the first video.

10. The control apparatus according to claim 8, wherein the one or more processors execute the instructions to determine whether or not the condition is satisfied by comparing a word or sentence included in a caption describing the first video with a word or sentence included in a caption describing the second video.

11. The control apparatus according to claim 8, wherein the one or more processors execute the instructions to, based on a word or sentence included in a caption describing the first video, generate information indicating a word or sentence that a caption describing the second video should include for the condition to be satisfied.

12. The control apparatus according to claim 1, wherein the one or more processors execute the instructions to divide a video into regions in accordance with a position of an object in the video, and perform processing for identifying an object in each region.

13. The control apparatus according to claim 1, wherein the one or more processors execute the instructions to:
control an angle of view of the second image capturing device; and
in response to a determination that the first video can be switched to the second video, stop the change of the angle of view of the second image capturing device.

14. The control apparatus according to claim 1, wherein the one or more processors execute the instructions to:
control an angle of view of the second image capturing device; and
prior to a determination that the first video can be switched to the second video, continuously change the angle of view of the second image capturing device.

15. The control apparatus according to claim 13, wherein the one or more processors execute the instructions to control pan, tilt, and zoom of the second image capturing device.

16. The control apparatus according to claim 1, wherein the one or more processors execute the instructions to, in response to a determination that the first video can be switched to the second video, make a notification that the first video can be switched to the second video.

17. An image capturing control method comprising:
identifying content of a video;
determining a video cutting type indicating a relationship between videos at a time of switching video from a first video captured by a first image capturing device in accordance with a result of identifying content of the first video;
determining whether a result of identifying content of a second video captured by a second camera device satisfies a condition corresponding to the video cutting type, wherein the second camera device captures the second video while changing an angle of view; and
determining that the first video can be switched to the second video based on a result of the determination that the condition is satisfied.

18. A non-transitory computer-readable medium storing a program executable by a computer to perform a method comprising:
identifying content of a video;
determining a video cutting type indicating a relationship between videos at a time of switching video from a first video captured by a first image capturing device in accordance with a result of identifying content of the first video;
determining whether a result of identifying content of a second video captured by a second camera device satisfies a condition corresponding to the video cutting type, wherein the second camera device captures the second video while changing an angle of view; and
determining that the first video can be switched to the second video based on a result of the determination that the condition is satisfied.
